(19) United States
(12) Patent Application Publication
(10) Pub. No.: US 2015/0116291 A1
(43) Pub. Date: Apr. 30, 2015

(54) ANTENNA ASSEMBLY FOR AN ELECTRONIC PEN

(71) Applicant: Livescribe Inc., Oakland, CA (US)

(72) Inventors: Chi Kin Benjamin Leung, San Jose, CA (US); Bharadvaj R. Podduturi, American Canyon, CA (US)

(21) Appl. No.: 14/523,846

(22) Filed: Oct. 25, 2014

Related U.S. Application Data
(60) Provisional application No. 61/895,882, filed on Oct. 25, 2013.

(51) Int. Cl. G06F 3/0354; G06F 3/038; H01Q 1/24

(52) U.S. Cl. CPC G06F 3/03545; H01Q 1/243; G06F 3/0383
USPC 345/179

(57) ABSTRACT

An electronic smart pen is disclosed that comprises an antenna assembly to enable wireless communication with an external communication device. The antenna assembly comprises a flexible thin printed circuit board film. A transmission window made of a substantially non-conductive material is exposed to an exterior of the pen through an opening in a housing made of a substantially conductive material. The antenna is placed within the enclosure of the housing next to the transmission window such that electromagnetic communications to and from the antenna assembly can pass through the transmission window despite the shielding effects of the conductive housing, thus yielding sufficient power gain and efficiency for wireless communication.

### CROSS REFERENCE To RELATED APPLICATIONS

The application claims the benefit of Provisional Application No. 61/895,882, filed on Oct. 25, 2013, which is incorporated herein by reference.

### BACKGROUND

1. Field of the Invention

This invention relates generally to a smart pen, and more particularly to an antenna module integrated within the smart pen.

2. Description of the Related Art

A smart pen is an electronic device that digitally captures writing gestures of a user and converts the captured gestures to digital information that can be utilized in a variety of applications. For example, in an optics-based smart pen, the smart pen includes an optical sensor that detects and records coordinates of the pen while writing with respect to a digitally encoded surface (e.g., a dot pattern). The smart pen computing environment can also collect contextual content (such as recorded audio), which can be replayed in the digital domain in conjunction with viewing the captured writing. The smart pen can therefore provide an enriched note taking experience for users by providing both the convenience of operating in the paper domain and the functionality and flexibility associated with digital environments. Typically, a smart pen can be communicatively coupled to an external computing device via a cable or wireless interface in order to transfer data between the computing device and the smart pen.

### SUMMARY

An embodiment includes an electronic smart pen comprising a substantially cylindrical housing that has an opening and is made of a substantially conductive material, a transmission window, an electronic assembly internal to the housing, and an antenna assembly. The transmission window further comprises a substantially non-conductive material and is structured within the opening of the housing. The antenna assembly is electrically connected with the electronics assembly and is internal to the housing. The antenna assembly is also positioned proximate to the transmission window in the opening of the housing such that the antenna assembly transmits signals produced by the electronics assembly through the transmission window and the antenna assembly receives external signals through the transmission window.

### BRIEF DESCRIPTION OF THE DRAWINGS

FIG. 1A is a diagram of an embodiment of a smart pen showing an antenna assembly integrated into the pen's housing having a radio frequency (RF) transmission window.

FIG. 1B is a perspective view of an embodiment of a smart pen showing the RF transmission window.

FIG. 2 is an exploded three-dimensional diagram of an embodiment of a smart pen device showing an antenna assembly and a transmission window.

FIGS. 3A, 3B and 3C are diagrams of embodiments showing an antenna assembly integrated with a sub housing of a smart pen and a coaxial cable that electrically connects the antenna assembly with a main PCB assembly's circuitry.

FIGS. 4A and 4B are diagrams of embodiments of a smart pen showing an arrangement of an antenna assembly within the pen's housing.

FIG. 4C is a perspective view of an embodiment of a smart pen showing the RF transmission window and enclosing an antenna assembly by the pen's housing.

FIG. 5A is a plot of power gain as a function of a transmission frequency for an antenna assembly enclosed within a housing of a smart pen, according to one embodiment.

FIG. 5B is a plot of power gain as a function of a radiation efficiency for an antenna assembly enclosed within a housing of a smart pen, according to one embodiment.

FIG. 6 is a diagram of an embodiment of a smart pen-based computing system.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

A smart pen device includes an antenna assembly that is integrated within a housing of a smart pen to facilitate wireless communication of the smart pen with an external communication device. The antenna assembly is positioned and structured to enable transmission and reception of electromagnetic signals through a substantially non-conductive transmission window in an otherwise conductive housing of the smart pen.

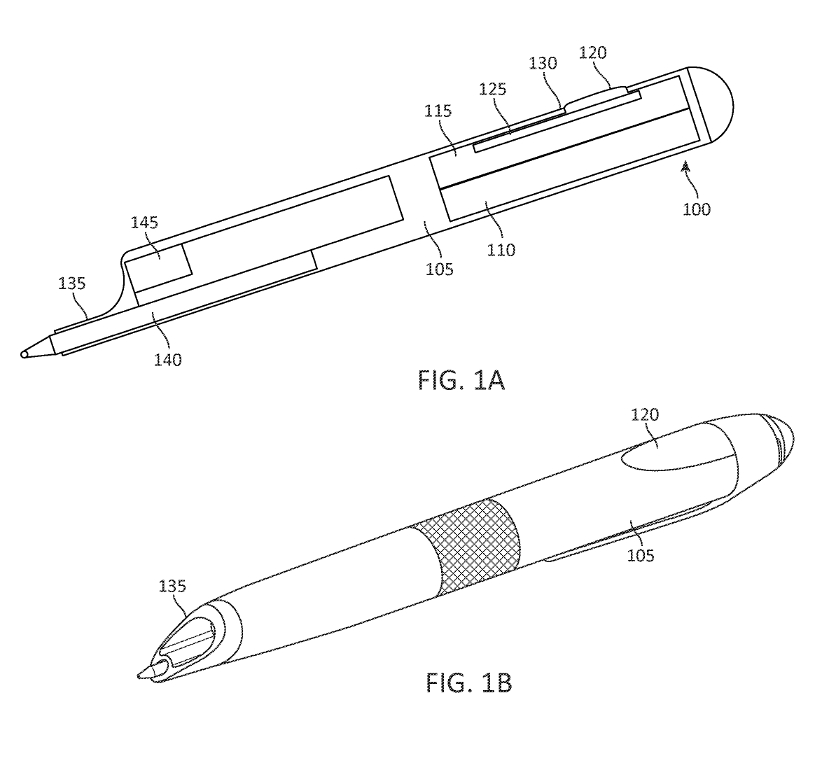

FIG. 1A illustrate an embodiment of a smart pen 100. The smart pen 100 shown in FIG. 1A comprises a housing 105, a sub housing top 110, a sub housing bottom 115 having a radiation transmission window 120, and an antenna assembly 125 positioned against the inside of the pen's sub housing bottom 115. The housing 105 has a tube-shaped form and comprises a conductive material, e.g. a metal or metallic composition. For example, the housing 105 may comprise aluminum, metal composite, or other substantially conductive material that acts to shield electromagnetic signals from the antenna from the external environment and vice versa.

In addition, a tube-shaped form comprising a metal, e.g. aluminum, may also provide structural rigidity of the housing 105 and allows for reducing the outer diameter of the smart pen 100.

The antenna assembly 125 and other electronics of the smart pen (not shown in FIG. 1A) reside within a sub housing collectively formed by the sub housing bottom 115 and sub housing top 110 within the housing 105. The antenna assembly 125 in these embodiments provides a wireless communication interface such as, for example, a Bluetooth, Wi-Fi, WiMax, 3G, and 4G to enable communication with other devices or a network.

The sub housing bottom 115 includes a transmission window 120 exposed to the pen's exterior through an opening 130 in the housing 105. The transmission window 120 comprises a material that has low electromagnetic shielding characteristics, e.g., is non-conductive (insulating) and/or non-magnetic. Embodiments of the transmission window 120 comprise materials that minimally interfere with electromagnetic signals to or from the antenna assembly 125. For example, the transmission window 120 comprises a polymeric, non-conductive material, e.g. polyethylene, polypropylene, polyvinyl chloride and the like. The transmission window 120 allows electromagnetic waves, e.g. radio frequency waves, to be communicated externally to the smart pen 100 to and from the antenna assembly 125. In one embodiment, the directional length of the opening 130 and thus of the transmission window 120 is about, but at least not significantly smaller, than the wavelength of the antenna's transmission to prevent substantial shielding effect by the conductive housing 105. The antenna assembly 125 is positioned against the inside of transmission window 120 to allow transmission of the electromagnetic waves directly through the window 120. In one embodiment, the antenna assembly 125 is electrically connected with the conductive housing 105 to enhance the transmission performance.

The shown embodiment further comprises a stylus tip 135, a marker 140 and an imaging system 145, wherein other optional components of the smart pen 100 are omitted for clarity of description.

A perspective view of an embodiment of the fully assembled smart pen 100 is shown in FIG. 1B. The housing 105 encloses the antenna assembly 125 only exposing the transmission window 120, under which the antenna assembly 125 resides inside the pen. In one embodiment, the transmission window 120 has the shape of a curved half ellipse with the length of its long axis measuring in the range of 20-28 mm (e.g., 24 mm) and of its short axis in the range of 8-14 mm (e.g., 11 mm), whereas the overall length of the pen is in the range of 140-160 mm (e.g., 154 mm) with the pen's diameter in the range of about 16-20 mm (e.g., 18.6 mm). These dimensions are merely representative examples and embodiments of the invention can also include pens with widely varying dimensions.

### Components of a Smart Pen System

### 1. Assembly of Smart Pen System

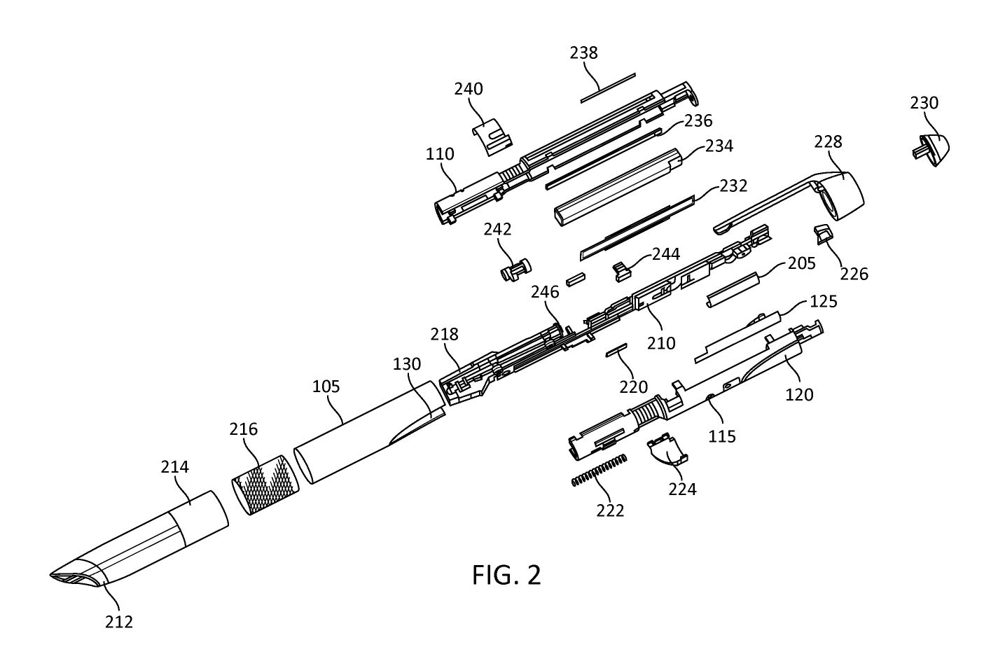

FIG. 2 illustrates an exploded view of an embodiment of a smart pen 100 including: a housing 105 with an opening 130, a sub housing bottom 115 with a transmission window 120, a sub housing top 110, an antenna assembly 125, an antenna foam pad 205, and a main PCB assembly 210. Additional components of the smart pen 100 are shown in FIG. 2, while other optional components of the smart pen 100 are omitted from FIG. 2 for clarity of description including, for example, indicator lights, a pen down or pen up sensor, onboard memory and other electronic components attached to the main PCB assembly 210, and other components. In alternative embodiments, the smart pen 100 may have fewer, additional, duplicate, or different components than those shown in FIG. 2.

The main PCB assembly 210 houses electronics of the smart pen 100 (e.g., a processor, memory, power components, circuit elements, etc.) and electrically couples to the antenna assembly 125. One embodiment of the integrated antenna assembly 125 comprises a flexible and thin antenna film that allows the antenna assembly 125 to conform to a curved and half-cylindrical shape fitted against the sub housing bottom 115. In some embodiments, an antenna foam pad 205 acting as an insulator is located between the antenna assembly 125 and the main PCB assembly 210 to prevent direct contact of the antenna assembly 125 with the main PCB assembly 210. The foam pad 205 also provides structural support for the flexible antenna film of the antenna assembly 125 by pressing the antenna film against the sub housing bottom 115. A pressure-sensitive adhesive (not shown) placed between the antenna film and the sub housing affixes the antenna film to the inside of the sub housing. When the smart pen's components are assembled the main PCB assembly 210 presses against foam pad 205, which then asserts force against the antenna film and the pressure-sensitive adhesive, thus activating the pressure-sensitive adhesive to affix the antenna film to the sub housing bottom. The combination of the foam pad 205, main PCB assembly 210, sub housing bottom 115, sub housing top 110, pressure-sensitive adhesive, and housing 105 of the smart pen 100 thus provides structural integrity to the antenna film after the pen is assembled without interfering with the pen's aesthetic design and other functions.

As shown in FIG. 2, in some embodiments, the smart pen 100 includes a stylus tip 212, a housing tip assembly 214, a twist ring 216, a sensor carriage assembly 218, a flexible FPC connector tape 220, a carriage spring 222, a left part of a twist cam 224, a light pipe 226, a clip 228, a capacitive cap assembly 230, a battery insulator 232, a battery 234, a battery adhesive 236, a clip housing tap 238, a right part of a twist cam 240, an activator 242, a ground tap 244, and a paddle 246.

### 2. Antenna Assembly

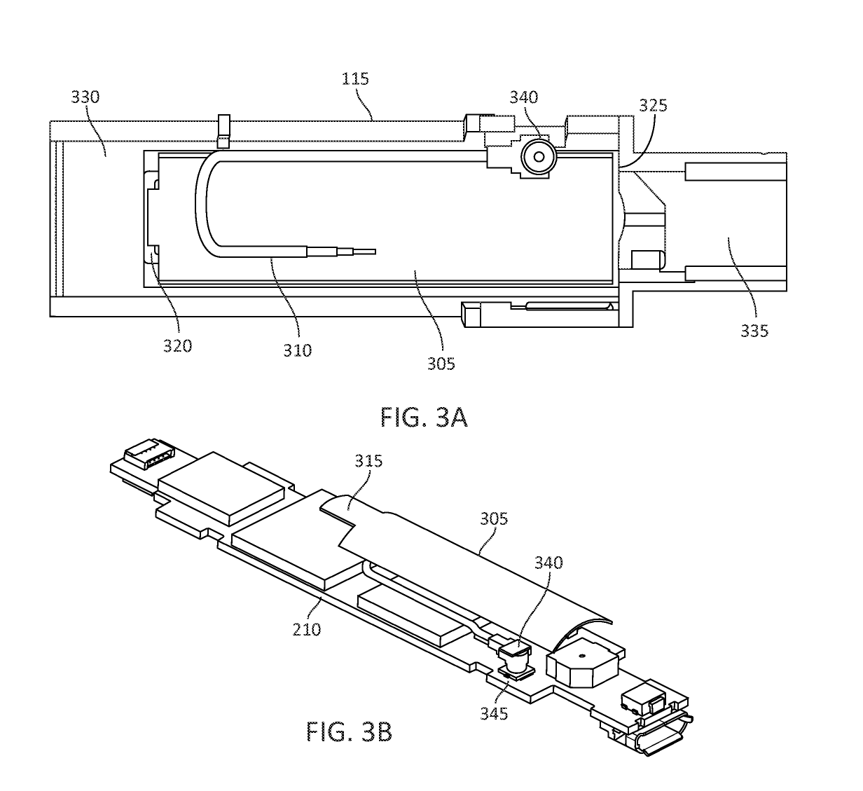

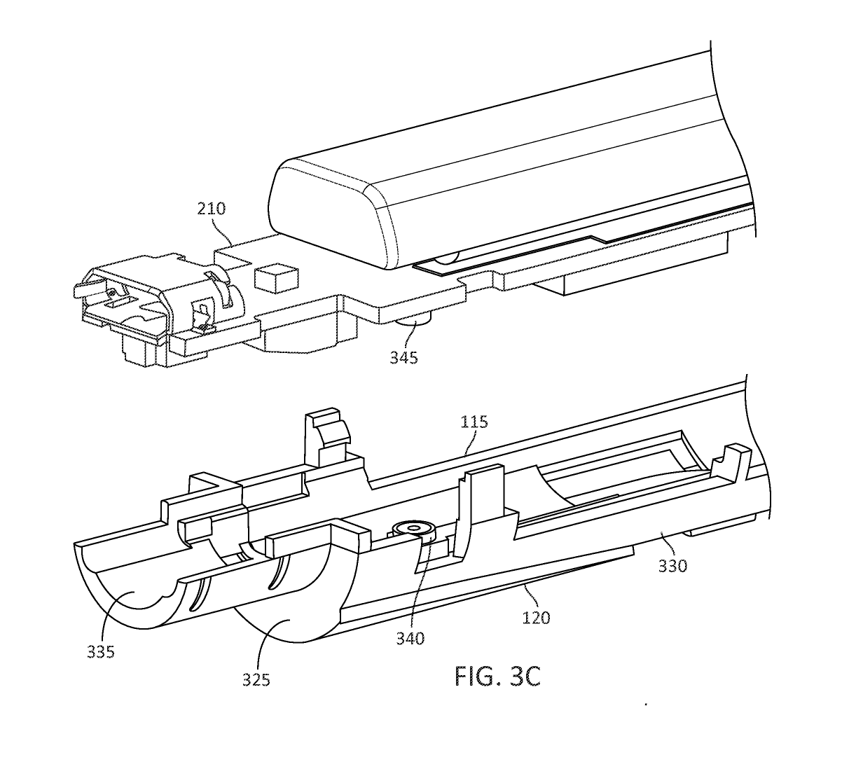

FIGS. 3A, 3B and 3C are diagrams of embodiments of an antenna assembly 125 incorporated within a sub housing bottom 115 of the smart pen 110. One embodiment of the integrated antenna assembly 125 comprises in addition to a flexible and thin antenna film 305 a coaxial cable 310 connected with the antenna film 305 and a coaxial connector 340.

In some embodiments, the antenna film 305 is of substantially rectangular shape and comprises a thin conductive layer enclosed by an insulating layer. For example, the antenna film 305 is a flexible printed circuit board (PCB) that comprises a thin insulating polymer film covering a thin metal layer of a conductive material such as copper. In other embodiments, the antenna film 305 comprises a flexible film of multiple, alternating conductive and insulating layers enclosed in an insulating layer. Thus, the antenna assembly 125 is configured to be integrated into a sub housing 115 of the smart pen using minimal volume, yet yielding a sufficient range of radiation transmission from the smart pen for wireless communication. In one embodiment, for example, the size of the rectangular portion of the antenna film 305 is approximately in the range of 5-15 mm (e.g., 9mm) by 20-50 mm (e.g., 30 mm). Furthermore, in one embodiment, the thickness of the antenna film is in the range of about 0.2 to about 0.6 mm (e.g., about 0.4 mm) with a curvature radius in the range of 6-12 mm (e.g., 9 mm).

The electronics on the main PCB assembly 210 electrically connected with the coaxial cable 310 of the antenna assembly 125. In particular, FIG. 3A illustrates the integration of the antenna assembly 125 with the sub housing bottom 115. In its flat configuration the flexible antenna film 305 of the antenna assembly 125 has a rectangular shape with a tab 315 projecting from one of the shorter sides of the rectangle. The flexible antenna film is curved along its short axis to fit the curved shape interior of the sub housing bottom 115 with the film contacting the interior side of the sub housing bottom 115. The tab 315 of the antenna film 305 fits through a groove 320 in the sub housing bottom 115 and contacts the exterior side of the sub housing bottom 115. In one embodiment the size of the tab 315 in the range of 2-10 mm by 2-10 mm, with one particular embodiment having a tab 315 of approximately 4.4 mm by 4.8 mm. In an embodiment, the antenna film is positioned such that its side, which is opposite to the tab 315, fits flush against an edge 325 of the sub housing bottom. The edge 325 separates the half-cylindrical tube 330 of the sub housing bottom 115 from a shorter half-cylindrical extension 335 that has a smaller diameter than the tube 330. The groove-interlocked tab 315 and the sub housing edge 325 prevent the antenna film 305 from moving in the pen's longitudinal direction upon assembly.

The coaxial cable 310 is electrically connected with the conducting layer of the antenna assembly 125. In one embodiment, the connection is made by soldering the conducting line of the coaxial cable 310 at one end to the conducting layer through the insulating layer of the antenna film. The other end of the coaxial cable 310 shown in FIGS. 3A and 3B is electrically connected with a coaxial male connector 340 that is configured to connectively mate with a corresponding coaxial female socket 345 on the main PCB assembly 210. As illustrated in FIG. 3B, the coaxial socket 345 connects to the circuitry of the main PCB assembly 210 to close the connection between the antenna assembly 125 and the circuitry.

FIG. 3C illustrated the relative orientation of the main PCB assembly 210 with respect to the sub housing bottom 115 holding the antenna assembly 125 such that the coaxial connector of the antenna assembly 125 in a position to couple with the socket 345 mounted on the main PCB assembly 210. In addition, an antenna foam pad 205 is placed between antenna film and the main PCB assembly 210 to insulate the antenna assembly 125 from the main PCB assembly 210. A pressure-sensitive adhesive affixed the antenna assembly 125 to the inside of the sub housing bottom 115.

### 3. Integration of Antenna Assembly

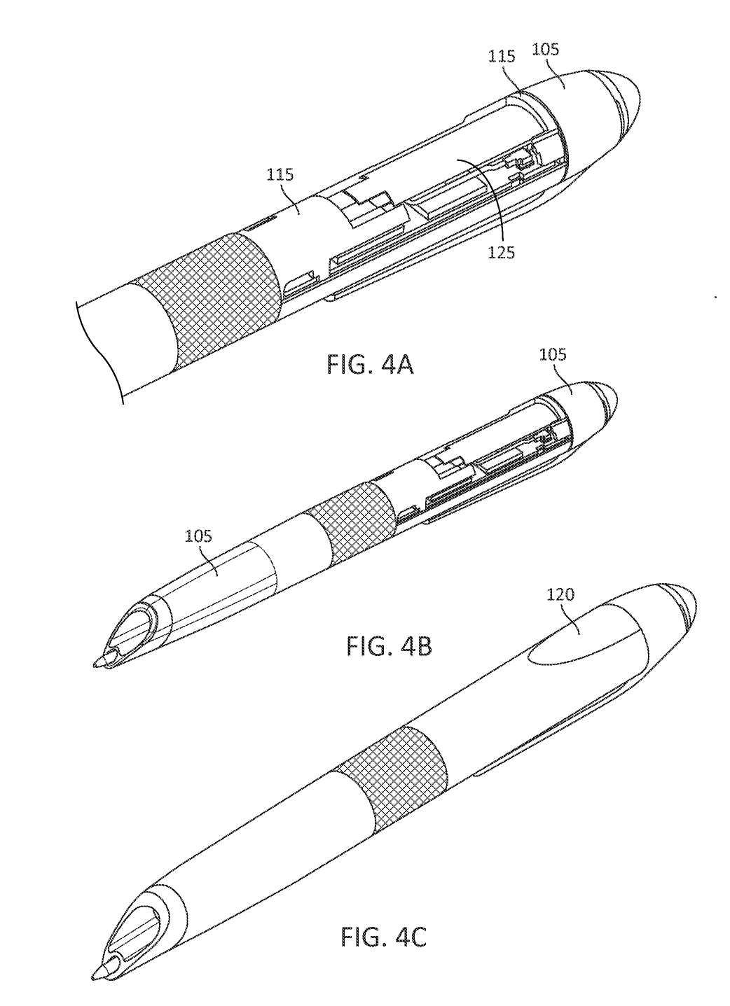

FIGS. 4A and 4B are diagram of embodiments of an assembled smart pen with a cutout view to show the placement of the antenna assembly 125 within the housing 105. In addition, FIG. 4C shows an embodiment of an assembled smart pen 100 with the antenna assembly 125 fully enclosed in the housing 105 and positioned under the transmission window 120.

### 4. Transmission Spectrum

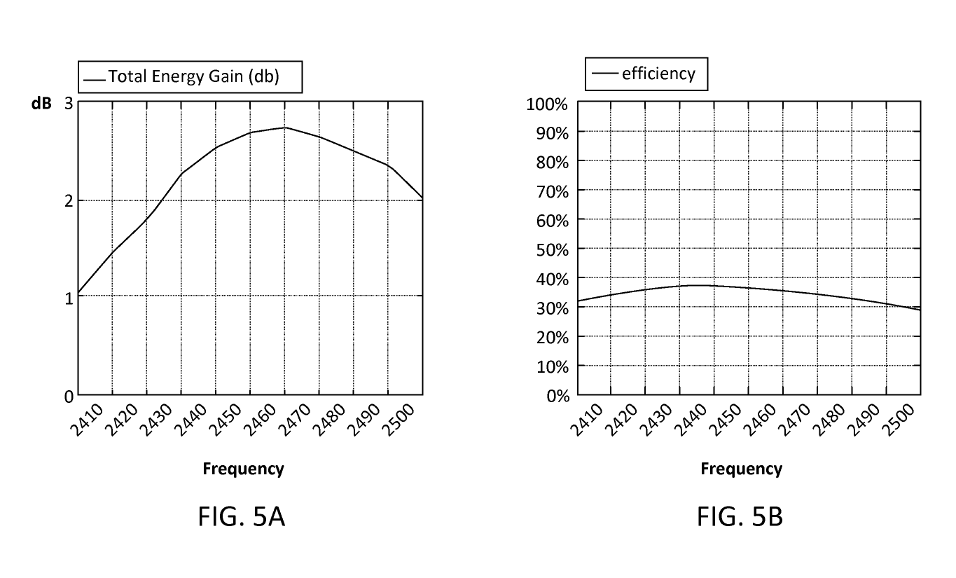

FIG. 5A is a graph illustrating the power gain as a function of the transmission frequency for an example embodiment of the antenna assembly 125 integrated with a smart pen 100. The gain is defined as the ratio of the power that the antenna produces when measured in the direction of the antenna's beam axis and at a far field region to a hypothetical lossless isotropic antenna. This hypothetical isotropic antenna is omnidirectional, transmitting with equal power in every direction. The unit of gain ratio is decibels (dB). The plot in FIG. 5A shows the total gain in dB with a maximal gain of 2.7 dB at a frequency of about 2460 MHz. The gain of antenna assembly in this embodiment exceeds 2 dB within a frequency range of about 2425 MHz to about 2500 MHz, while exceeding 1 dB from about 2400 MHz to about 2425 MHz.

The overall radiation efficiency of an example embodiment of the antenna assembly 125 is show in the plot of FIG. 5B. The efficiency measures the ratio of amount of power transmitted from the antenna in form of an electromagnetic wave to the amount of electric power received at the antenna terminals, e.g. the coaxial wire shown in FIGS. 3A and 3B. The maximal efficiency of the embodied antenna assembly measured at about 38% in a frequency range of approximately about 2430 MHz to about 2440 MHz. The antenna's efficiency maintained an efficiency of at least about 30% from about 2400 MHz to about 2500 MHz.

This power gain and radiation efficiency shown in FIGS. 5A-B for the example antenna assembly would allow for wireless communication in the above frequency range up to a distance of at least 10 meters. The plots in FIGS. 5A-B are provided merely as one example of antenna characteristics. Other embodiments of the smart pen 100 may include an antenna assembly 125 having different characteristics than those illustrated.

### Overview of a Computing System for a Smart Pen

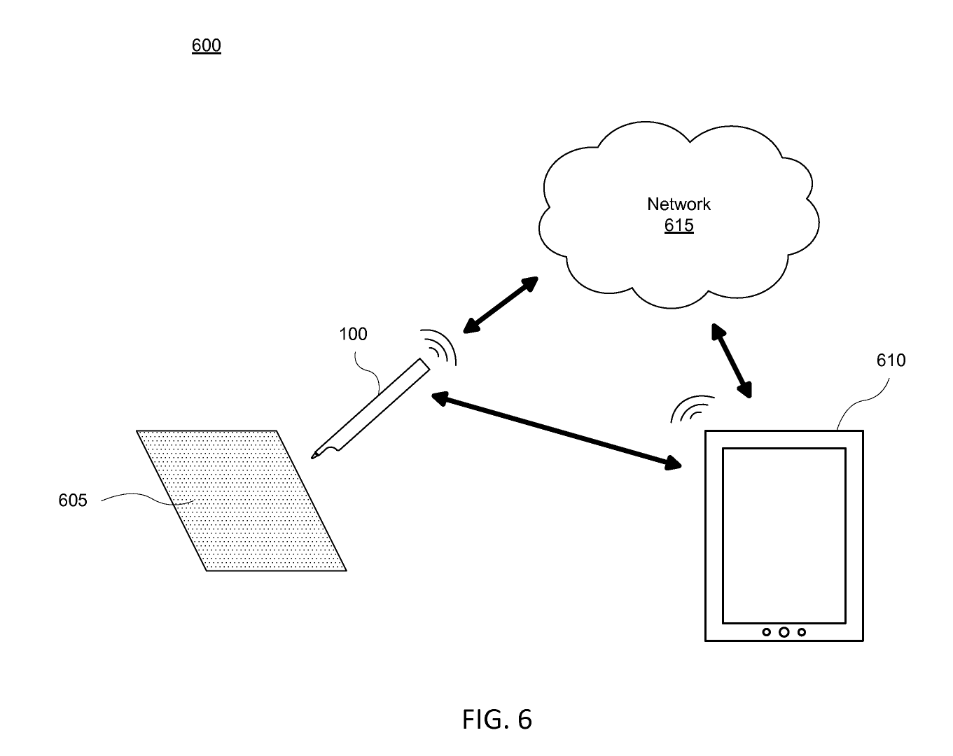

FIG. 6 illustrates an embodiment of a pen-based computing system 600 providing an example use for the smart pen 100 described herein. The pen-based computing system comprises a writing surface 605, a smart pen 100, a computing device 610, and a network 615. In alternative embodiments, different or additional devices may be present such as, for example, additional smart pens 100, writing surfaces 605, and computing devices 610 (or one or more device may be absent).

The smart pen 100 is an electronic device that digitally captures interactions with the writing surface 605 (e.g., writing gestures and/or control inputs). The smart pen 100 is communicatively coupled to the computing device 610 either directly or via the network 615. The captured writing gestures and/or control inputs may be transferred from the smart pen 100 to the computing device 610 (e.g., either in real time or at a later time) for use with one or more applications executing on the computing device 610. Furthermore, digital data and/or control inputs may be communicated from the computing device 610 to the smart pen 100 (either in real time or as an offline process) for use with an application executing on the smart pen 100. Commands may similarly be communicated from the smart pen 100 to the computing device 610 for use with an application executing on the computing device 610. The pen-based computing system 600 thus enables a wide variety of applications that combine user interactions in both paper and digital domains.

In one embodiment, the smart pen 100 comprises a writing instrument (e.g., an ink-based ball point pen, a stylus device without ink, a stylus device that leaves “digital ink” on a display, a felt marker, a pencil, or other writing apparatus) with embedded computing components and various input/output functionalities. A user may write with the smart pen 100 on the writing surface 605 as the user would with a conventional pen. During the operation, the smart pen 100 digitally captures the writing gestures made on the writing surface 605 and stores electronic representations of the writing gestures. The captured writing gestures have both spatial components and a time component. In one embodiment, the smart pen 100 captures position samples (i.e., coordinate information) of the smart pen 100 with respect to the writing surface 605 at various sample times and stores the captured position information together with the timing information of each sample. The captured writing gestures may furthermore include identifying information associated with the particular writing surface 605 such as, for example, identifying information of a particular page in a particular notebook so as to distinguish between data captured with different writing surfaces 605.

In one embodiment, the smart pen 100 is capable of outputting visual and/or audio information. The smart pen 100 may furthermore execute one or more software applications that control various outputs and operations of the smart pen 100 in response to different inputs.

In one embodiment, the writing surface 605 comprises a sheet of paper (or any other suitable material that can be written upon) and is encoded with a pattern (e.g., a dot pattern) that can be sensed by the smart pen 100. In another embodiment, the writing surface 605 comprises electronic paper, or e-paper, or may comprise a display screen of an electronic device (e.g., a tablet, a projector), which may be the computing device 610 or a different device. Movement of the smart pen 100 may be sensed, for example, via optical sensing of the smart pen 100, via motion sensing of the smart pen 100, via touch sensing of the writing surface 605, via a fiducial marking, or other suitable means.

In an embodiment, the computing device 610 additionally captures contextual data while the smart pen 100 captures written gestures. In an alternate embodiment, the smart pen 100 or a combination of a smart pen 100 and a computing device 610 captures contextual data. The contextual data may include audio and/or video from an audio/visual source (e. g., the surrounding room). Contextual data may also include, for example, user interactions with the computing device 610 (e.g. documents, web pages, emails, and other concurrently viewed content), information gathered by the computing device 610 (e.g., geospatial location), and synchronization information (e.g., cue points) associated with time-based content (e.g., audio or video) being viewed or recorded on the computing device 610. The computing device 610 stores the contextual data synchronized in time with the captured writing gestures (i.e., the relative timing information between the captured written gestures and contextual data is preserved). Furthermore, in an alternate embodiment, some or all of the contextual data can be stored on the smart pen 100 instead of, or in addition to, being stored on the computing device 610.

The computing device 610 may comprise, for example, a tablet computing device, a mobile phone, a laptop or desktop computer, or other electronic device (e.g., another smart pen 100). The computing device 610 may execute one or more applications that can be used in conjunction with the smart pen 100. For example, written gestures and contextual data captured by the smart pen 100 may be transferred to the computing system 610 for storage, playback, editing, and/or further processing. Additionally, data and or control signals available on the computing device 610 may be transferred to the smart pen 100. Furthermore, applications executing concurrently on the smart pen 100 and the computing device 610 may enable a variety of different real-time interactions between the smart pen 100 and the computing device 610. For example, interactions between the smart pen 100 and the writing surface 605 may be used to provide input to an application executing on the computing device 610 (or vice versa). Additionally, the captured stroke data may be displayed in real-time in the computing device 610 as it is being captured by the smart pen 100.

Additional Considerations and Embodiments

The foregoing description of the embodiments has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a non-transitory computer-readable medium containing computer program instructions, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium, which includes any type of tangible media suitable for storing electronic instructions, and coupled to a computer system bus. Furthermore, any computing systems referred to in the specification may include a single processor or may be architectures employing multiple processor designs for increased computing capability.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed:

1. An electronic smart pen comprising:
a substantially cylindrical housing comprising a substantially conductive material, the housing including an opening;
a transmission window comprising a substantially non-conductive material, the transmission window;
a sub housing including the transmission window on an external surface of the sub housing, the sub housing substantially enclosing the electronics assembly and the antenna assembly, the sub housing substantially enclosed within the housing a positioned such that the transmission window is exposed through the opening in the housing;
an electronics assembly internal to the housing; and
an antenna assembly comprising a flexible circuit board substantially conforming to a curvature of an interior of the sub housing, the antenna assembly electrically connected with the electronics assembly via a coaxial wire, the antenna assembly internal to the housing and positioned proximate to the transmission window in the opening of the housing such that the antenna assembly transmits signals produced by the electronics assembly through the transmission window and the antenna assembly receives external signals through the transmission window, wherein the flexible print circuit board.

2. An electronic smart pen comprising:
a substantially cylindrical housing comprising a substantially conductive material, the housing including an opening;
a transmission window comprising a substantially non-conductive material, the transmission window structured within the opening of the housing;
an electronics assembly internal to the housing;
an antenna assembly electrically connected with the electronics assembly, the antenna assembly internal to the housing and positioned proximate to the transmission window in the opening of the housing such that the antenna assembly transmits signals produced by the electronics assembly through the transmission window and the antenna assembly receives external signals through the transmission window.

3. The electronic smart pen of claim 2, further comprising:
a sub housing including the transmission window on an external surface of the sub housing, the sub housing substantially enclosing the electronics assembly and the antenna assembly, the sub housing substantially enclosed within the housing and positioned such that the transmission window is exposed through the opening in the housing.

4. The electronic smart pen of claim 2, wherein the antenna assembly comprises:
a flexible print circuit board substantially conforming to a curvature of an interior of the sub housing the flexible print circuit board positioned proximate to the transmission window to enable the antenna assembly to transmit the signals produced by the electronics assembly through the transmission window and to enable the antenna assembly to receive the external signals through the transmission window.

5. The electronic smart pen of claim 4, wherein the flexible print circuit board further comprises a tab structured to interlock with a groove within the sub housing in a manner that substantially secures the flexible print circuit board along the longitudinal axis of the smart pen.

6. The electronic smart pen of claim 4, wherein the flexible print circuit board has a thickness in the range of 0.2 to 0.6 millimeters.

7. The electronic smart pen of claim 4, wherein the flexible print circuit board has a substantially rectangular shape with a first dimension in the range of 5 to 15 millimeters and a second dimension in the range of 20 to 50 millimeters.

8. The electronic smart pen of claim 2, wherein the substantially conductive material of the housing comprises aluminum or an aluminum alloy.

9. The electronic smart pen of claim 2, wherein the substantially non-conductive material of the transmission window comprises an inorganic polymeric material.

10. The electronic smart pen of claim 2, wherein the signal transmitted by the antenna assembly comprises one or more of a Bluetooth signal, a Wi-Fi signal, a WiMax signal, a 3G signal and a 4G signal.

11. The electronic smart pen of claim 2, wherein the signal transmitted by the antenna assembly comprises a radio frequency signal within the range of approximately 2400 MHz to 2500 MHz.

12. The electronic smart pen of claim 2, wherein the antenna assembly provides a power gain of at least 1 dB.

13. The electronic smart pen of claim 2, wherein the antenna assembly provides a radiation efficiency of at least 30% over a frequency range of approximately 2400 MHz to 2500 MHz.

14. The electronic smart pen of claim 2, wherein the antenna assembly provides a power gain of at least 2 dB.

15. The electronic smart pen of claim 2, wherein the antenna assembly provides a radiation efficiency of at least 38% over a frequency range of approximately 2400 MHz to 2500 MHz.
